(19) United States
(12) Patent Application Publication
(10) Pub. No.: US 2002/0171285 A1
(43) Pub. Date: Nov. 21, 2002

(54) Lock actuator

(76) Inventor: Ake Nelander, Bunkeflostrand (SE)

Correspondence Address: ST. ONGE STEWARD JOHNSTON & REENS, LLC, 986 BEDFORD STREET, STAMFORD, CT, 06905-5619, US

(21) Appl. No.: 10/125,322

(22) Filed: Apr. 18, 2002

Related U.S. Application Data
(63) Continuation of application No. PCT/SE00/01981, filed on Oct. 13, 2000.

(30) Foreign Application Priority Data
Oct. 18, 1999 (SE) 9903730-1

(51) Int. Cl. F16D 55/16; F16D 65/14; B60R 25/08; B60T 17/16

(52) U.S. Cl. 303/89; 188/72.8; 188/106 P

(57) ABSTRACT

A service brake actuator (1), preferably for a heavy road vehicle, comprises in a housing (3, 4) a fluid actuated piston (5) with a piston rod (6). A lock actuator (2) combined with the service brake actuator comprises an axially movable push rod (13) for actuating the piston (5), a rotatable screw rod (18) in self-locking thread engagement with the push rod for axially transferring the push rod, and an electric motor (25) for rotating the screw rod (18).

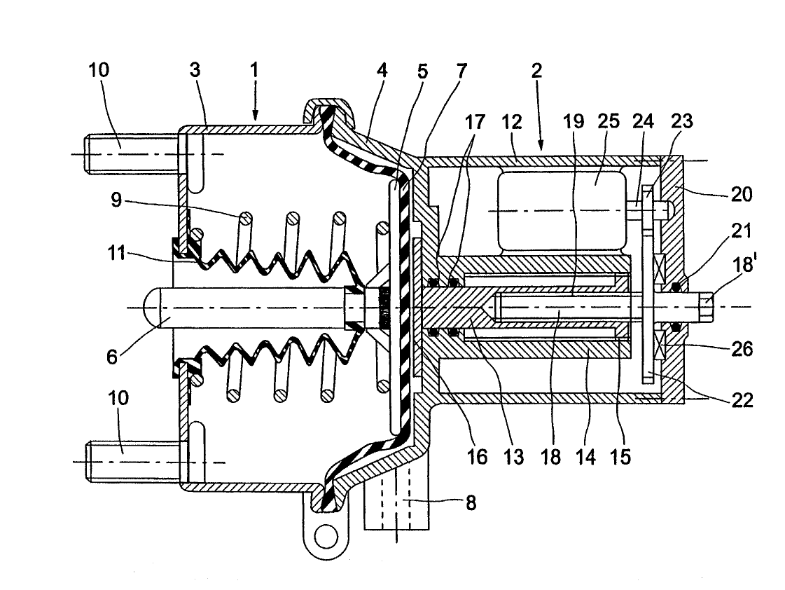

This application is a continuation of pending International Application PCT/SE00/01981 filed on Oct. 13, 2000, which designates the United States and claims priority of Swedish Application 9903730-1 filed on Oct. 18, 1999.

### FIELD OF THE INVENTION

The present invention relates to a lock actuator for combination with a service brake actuator for a vehicle, preferably a heavy road vehicle, the service brake actuator comprising in a housing a fluid actuated piston with a piston rod.

### BACKGROUND OF THE INVENTION

A parking braking of a vehicle can be performed by means of a parking brake actuator, mounted on the service brake actuator to form therewith a unit. Such a unit is commonly known for use on trucks and buses. As is well known in the art, the parking brake actuator may for example be a so-called spring brake actuator or an actuator with fluid actuation. The fluid normally used on heavy road vehicles is compressed air, but hydraulic fluid may equally well be utilized.

A special type of parking brake actuator is the so-called lock actuator, with which the present invention is concerned. The function of a lock actuator is to lock the service brake actuator in an applied condition, so that the service brake actuator also functions for the parking braking even in the absence of any fluid pressure.

### SUMMARY OF THE INVENTION

A lock actuator fulfilling different requirements with regard to simple and reliable design, small space need, and excellent maneuverability is according to the invention attained in that it comprises an axially movable push rod for actuating the piston of the service brake actuator, a rotatable member in self-locking thread engagement with the push rod for axially transferring the push rod, and an electric motor for rotating the rotatable member.

With this design the electric motor will only need to transfer the push rod into engagement with the piston of the applied service brake for accomplishing parking braking, locked by the self-locking thread engagement between the rotatable member and the push rod.

In a preferred embodiment the rotatable member is a screw rod in thread engagement with an internal thread in the push rod.

For accomplishing a suitable ratio between the motor and the screw rod the latter has a gear wheel in engagement with a gear wheel on the outgoing shaft of the electric motor.

### BRIEF DESCRIPTION OF THE DRAWING

The invention will be further described below under reference to the accompanying drawing showing a cross-sectional view of a brake actuator embodying the invention.

### DETAILED DESCRIPTION OF THE DRAWING

A brake actuator shown in the drawing comprises two major portions: a service brake actuator 1 and a so-called lock actuator 2.

The service brake actuator 1 is conventional and is only briefly described. In a housing comprising a lower part 3 and a cover part 4 there is a piston 5 and a piston rod 6, from which a pushing brake force may be delivered to further, not shown brake elements in a compressed air brake system for a heavy road vehicle, such as a truck or a bus.

In the shown case the service brake actuator 1 is of the diaphragm type, which means that a diaphragm 7 in contact with the piston 5 is clamped between the two housing parts 3, 4. Compressed air can be admitted to a service brake chamber at the diaphragm 7 through an inlet 8.

A piston return spring 9 is arranged between the piston 5 and the lower housing part 3, which is provided with screws 10 for its attachment. A bellows 11 may be arranged between the piston rod 6 and the lower housing part 3 for protecting the interior of a disc brake, to which the service brake 1 may be attached.

At the admission of compressed air through the inlet 8 the diaphragm 7, the piston 5 and thus the piston rod 6 will be pushed to the left in the drawing for accomplishing a brake application in a way well known in the art. A return stroke, when the compressed air pressure is again decreased, is brought about by the return spring 9.

The so-called lock actuator 2 is arranged in a casing 12 constituting an extension of the cover part 4 for the service brake actuator 1. A push rod 13 is movable in a sleeve 14 and is axially guided by a splines arrangement 15 therein. The push rod 13 is ended by a push plate 16 for engaging the diaphragm 7 and thus the piston 5 at its movement to the left in the drawing. The push rod 13 is sealed in the sleeve 14 by sealing 17.

A rotatable member, namely a rod 18 in the form of a screw, is in self-locking thread engagement with the push rod 13, namely with an internal thread 19 therein. The rod 18 extends through a casing cover 20 and is provided with an external tool grip 18′ for possible manual operation. A sealing 21 for the rod 18 is provided in the casing cover 20.

The screw rod 18 has a gear wheel 22 in engagement with a gear wheel 23 on an outgoing shaft 24 of an electric motor 25 within the casing 12. The motor shaft 24 may be journalled in the casing cover 20. An axial bearing 26 for the rod gear wheel 23 may be provided in the casing cover 20.

The purpose of the lock actuator 2 is to lock at will the service brake actuator 1 in an applied condition. Accordingly, when the service brake actuator 1 is applied by compressed air admitted through the inlet 8, it is possible to forward the push rod 13 (to the left in the drawing), until the push plate 16 gets in engagement with the diaphragm 7 on the piston 5, by rotating the electric motor 25 in the proper direction, the rotation being transmitted via the gear wheels 23 and 22 to the screw rod 18. Due to the self-locking engagement between the screw rod 18 and the push rod thread 19, the push rod 13 will remain in the attained position, until the motor 25 is rotated in the opposite direction for a return stroke, so that the service brake actuator 1 again can be used for service braking. The actuator 2 is accordingly a lock actuator, which can be used for parking braking.

It can be noted that by the shown and described design the motor 25 is only utilized to transfer the push rod 13 and not to transmit any specific force, which means that the overall design may be rather simple and space-saving relative to presently known alternatives.

The service brake actuator is shown as being of the diaphragm type, but a piston type actuator may equally well be used.

What is claimed is:

1. A lock actuator (2) for combination with a service brake actuator (1) for a vehicle, preferably a heavy road vehicle, the service brake actuator comprising in a housing (3, 4) a fluid actuated piston (5) with a piston rod (6), characterized in that the lock actuator (2) comprises an axially movable push rod (13) for actuating the piston (5), a rotatable member (18) in self-locking thread engagement with the push rod (13) for axially transferring the push rod (13), and an electric motor (25) for rotating the rotatable member (18).

2. A lock actuator according to claim 1, characterized in that the rotatable member is a screw rod (18) in thread engagement with an internal thread (19) in the push rod (13).

3. A lock actuator according to claim 2, characterized in that the screw rod (18) has a gear wheel (22) in engagement with a gear wheel (23) on the outgoing shaft (24) of the electric motor (25).

4. A lock actuator according to claim 3, characterized in that an axial bearing (26) is arranged between the rod gear wheel (22) and a casing cover (20) for the lock actuator (2).

5. A lock actuator according to claim 4, characterized in that the the screw rod (18) extends through the casing cover (20) and is provided with an external tool grip (18′).

6. A lock actuator according to claim 1, characterized in that the push rod (13) is guided by a sleeve (14) in the lock actuator (2) and that there is a splines arrangement (15) between the push rod (13) and the sleeve (14).

7. A lock actuator according to claim 1, characterized in that the push rod (13) is provided with a push plate (16) for engagement with the piston (5).
